(19) United States
(12) Patent Application Publication
(10) Pub. No.: US 2011/0176144 A1
(43) Pub. Date: Jul. 21, 2011

(54) Polarization Based Delay Line Interferometer

(75) Inventor: Zhiqiang Chen, Fremont, CA (US)

(73) Assignee: W2 OPTRONICS INC., Fremont, CA (US)

(21) Appl. No.: 12/888,414

(22) Filed: Sep. 23, 2010

Related U.S. Application Data
(60) Provisional application No. 61/295,766, filed on Jan. 18, 2010.

(51) Int. Cl. G01B 9/02

(52) U.S. Cl. 356/521

(57) ABSTRACT

This invention provides a compact delay-line interferometer that can be used in Differential Phase Shift Keying (DPSK) and Differential Quardratic Phase Shift Keying (DQPSK) demodulators. The delay-line interferometer is based on polarization components including beam shifter, beam splitter and wave plates. The realized demodulators can be used as either discrete components or integrated with balanced detectors. Time delay generated in the interferometer can be controlled with a phase shifter, using either thermal, piezoelectric, mechanical of electrical means. This application claims priority to US Provisional Patent Application Ser. No. 61/238,687, filed Sep. 1, 2009, titled “Polarization Based Interferometer.” This application also claims priority to US Provisional Patent Application Ser. No. 61/295,766, filed Jan. 18, 2010, titled “Delay-Line-Interferometer for Integration with Balanced Receivers.”

This application claims priority to US Provisional Patent Application Ser. No. 61/238,687, filed Sep. 1, 2009, titled “Polarization Based Interferometer.” This application also claims priority to US Provisional Patent Application Ser. No. 61/295,766, filed Jan. 18, 2010, titled “Delay-Line-Interferometer for Integration with Balanced Receivers.”

### BACKGROUND OF INVENTION

1. Field of Invention

Embodiments of the invention relate generally to optical communication systems and components, and more particularly, to an optical demodulator for high speed receivers.

2. Description of the Invention

In high speed fiber-optic communication systems, Differential Phase Shift Keying (DPSK) and Differential Quardratic Phase Shift Keying (DQPSK) modulation formats can be used to lower the penalty of dispersion and nonlinear effects. To decode DPSK or DQPSK signals, demodulators based on delay-line interferometers are needed before receivers.

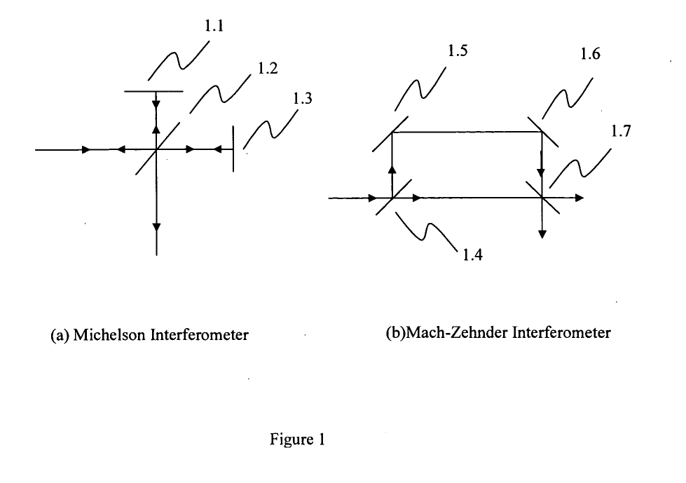

The delay-line interferometers can be a Michelson interferometer (FIG. 1a), a Mach-Zehnder interferometer (FIG. 1b), or a polarization interferometer. Most conventional fiber-optic delay-line interferometers employ a beam splitter (BS) to split the input beam into two arms. These two beams are then recombined at the same or another beam splitter by using mirrors to provide the required difference in light path. When a light path length difference exists between the two interfering beams, these conventional interferometers provide a sinusoidal spectral transmission function. Under the appropriate conditions, the transmission maxima and minima can be tuned to match the ITU frequency channels. Thus, such interferometers are usually employed in designing spectral interleavers for Dense Wavelength Domain Multiplexing (DWDM) applications.

Because of the light path difference, there is a time delay difference existing between the two arms. If the time delay difference of the interferometer in the two arms equals one period of the modulated pulses, the interferometer can be used in a DPSK demodulator or DQPSK demodulator. There are several approaches to implement such a demodulator, including free space Michelson interferometers, free space polarization interferometers and planar waveguide Mach-Zehnder interferometer.

US Patent Application Ser. No. 2007/0070505 describes a demodulator using a nonpolarization beamsplitter. US Patent Application Ser. No. 2006/0140695A1 uses a Michelson interferometer to implement a DQPSK demodulator. In these nonpolarization interferometer, a 50:50 beamsplitter is a critical part to maintain a low polarization dependent loss (PDL) and low polarization dependent frequency shift (PDFS).

Polarization based interferometers use polarization components to split beams, generate light path difference, and recombine beams. US Patent Application Ser. No. 2006/0171718A1 proposed a polarization based DQPSK demodulator. Light path difference is generated with a piece of polarization maintaining (PM) fiber.

However, all nonpolarization approaches require extremely low birefringence in the light paths. Otherwise, the device will show high polarization dependence in insertion loss and frequency shift. The polarization based interferometer disclosed hereafter is more advantageous due to its high performance in polarization dependence and extinction ratio.

### SUMMARY OF THE INVENTION

The object of this invention is to provide a compact delay-line interferometer that can be used in DPSK and DQPSK demodulators, by using polarization components. Furthermore, the realized demodulators can be used as either discrete components or integrated with balanced detectors. The novel interferometer consists of:
1. A polarization beam splitter to divide light into two interference arms.
2. A phase shifter that controls the path-length difference. The phase shifter can be air-spaced double mirrors, a solid substrate with separated reflecting surfaces, or a solid substrate with anti-reflection coatings.
3. A polarization beam splitter to combine light from two interference arms and redirect the light into two output ports.
4. Several beam shifters that are employed to split a beam of unpolarized light into two independent components of orthogonal polarization states, and/or to combine two polarization components into a beam of unpolarized light.
5. Several wave plates to change the polarization states of the light beams.

### BRIEF DESCRIPTION OF THE DRAWINGS

In order to illustrate the embodiments and principle of the invention the following drawings are included in the disclosure.

FIG. 1 shows the common configuration of a Michelson interferometer and a Mach-Zehnder interferometer.
1.1, 1.3, 1.5, 1.6—Mirror
1.2, 1.4, 1.7—Beam splitter

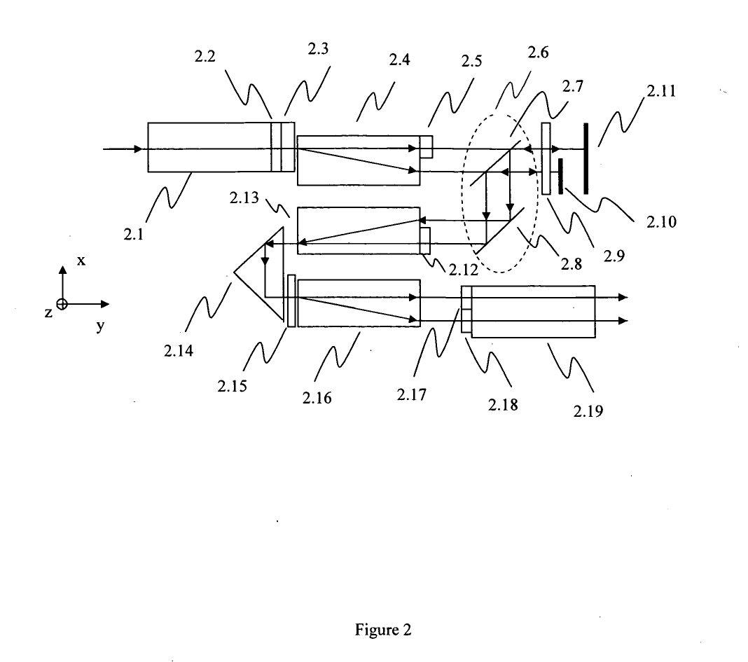

FIG. 2 shows the first embodiment of the polarization delay-line demodulator.
2.1, 2.4, 2.13, 2.16, 2.19—Beam Shifter; 2.2, 2.5, 2.12, 2.17, 2.18—Half-Wave Plate;
2.3, 2.7, 2.15—Quarter-Wave Plate; 2.6—Polarization Beam Splitter
2.7—Polarization Beam Splitting Interface; 2.8, 2.10, 2.11—Reflector
2.14—Prism

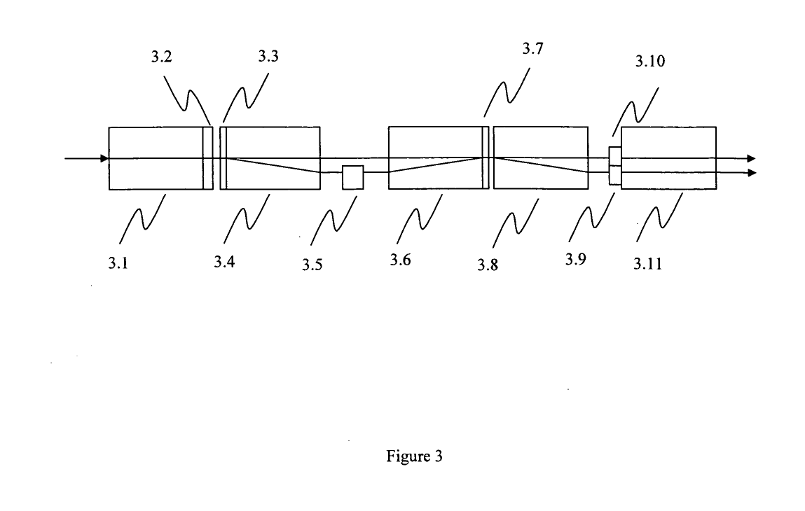

FIG. 3 shows the second embodiment of the polarization delay-line demodulator.
3.1, 3.4, 3.6, 3.8, 3.11—Beam Shifter; 3.2, 3.9, 3.10—Half-Wave Plate
3.3, 3.7—Quarter-Wave Plate; 3.5—Phase Shifter

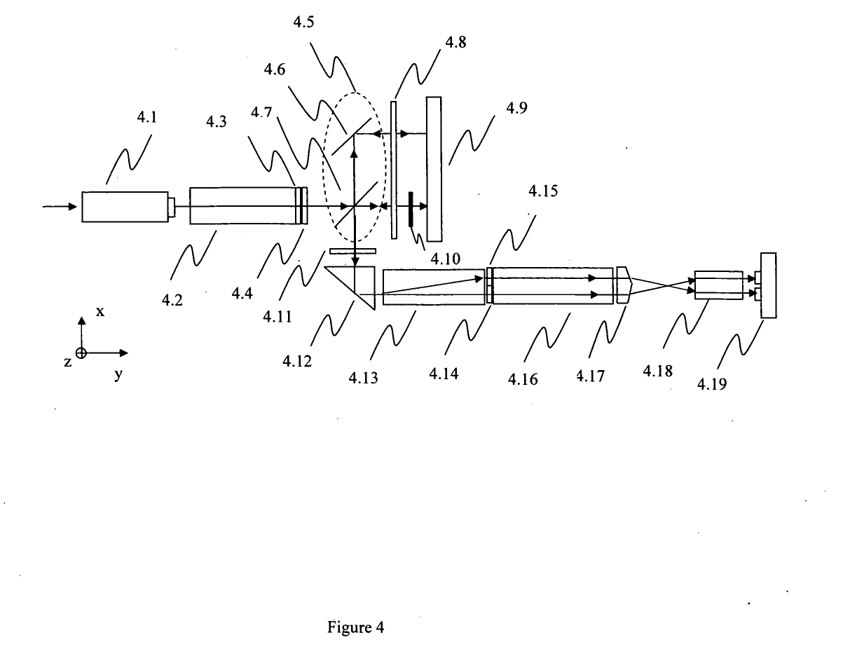

FIG. 4 shows the third embodiment of the polarization delay-line demodulator.
4.1—Collimator; 4.2, 4.13, 4.16—Beam Shifter; 4.3, 4.14, 4.15—Half-Wave Plate;
4.4, 4.8, 4.11—Quarter-Wave Plate; 4.5—Polarization Beam Splitter;
4.6, 4.9—Reflector; 4.7—Polarization Beam Splitting Interface; 4.10—Phase Shifter;
4.12—Prism; 4.17—Dual Prism; 4.18—Lens; 4.19—Detectors or Fibers

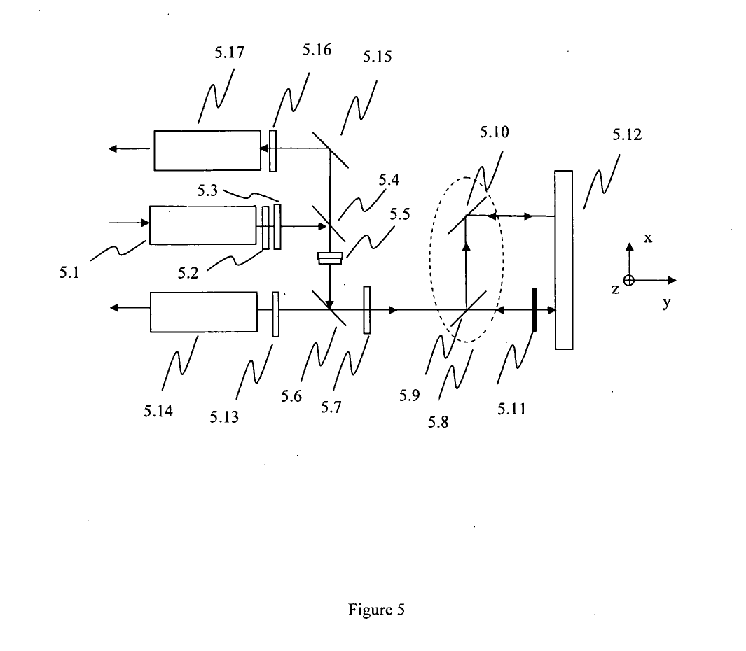

FIG. 5 shows the fourth embodiment of the polarization delay-line demodulator.
5.1, 5.14, 5.17—Beam Shifter; 5.2, 5.3, 5.13, 5.16—Half-Wave Plate;
5.7—Quarter-Wave Plate; 5.4, 5.6, 5.8—Polarization Beam Splitter;
5.9—Polarization Beam Splitting Interface; 5.10, 5.12, 5.15—Reflector;
5.5—Circulator Core; 5.11—Phase Shifter

### DETAILED DESCRIPTION OF THE INVENTION

The delay-line interferometer has a single fiber input and dual fiber outputs. There are two paths from the input to each of the output respectively. If these two paths differ by a whole number of wavelengths there is constructive interference and a strong signal at one output port, and destructive interference at the other output port.

### First Embodiment

Referring to FIG. 2, unpolarized incident light is separated into two polarization components by YVO4 beam shifter 2.1 in z-direction. Then one of the two polarization components is rotated 90 degrees by half-wave plate 2.2. Therefore after half-wave plate 2.2 and quarter-wave plate 2.3, each of the two components is further divided into two arms in x-direction by YVO4 beam shifter 2.4. Here 2.4 serves as a beam splitter. Half-wave plate 2.5 turns light in the two arms into the same polarization state. Spatial gap between mirrors 2.10 and 2.11 creates a phase shift between the two arms. Polarization beam splitter 2.6 and quarter-wave plate 2.9 are employed to direct the reflected light beam from 2.10 and 2.11 to beam shifter 2.13. Here beam shifter 2.13—serves as a beam combiner. The light beam combined from the two arms is then reflected back to beam shifter 2.16 after quarter-wave plate 2.15. Beam shifter 2.16 separates light into two output ports. Through wave plates 2.17 and 2.18, and beam shifter 2.19, the z-direction separated two components are recombined into nonpolarized state.

In such a polarization based optical interferometer, the intensity of one of the output ports is a sinusoidal function of frequency. We note that the intensity is a sinusoidal function of the optical frequency with transmission maxima occur at

f=mC/nL

where m is integer, C is the speed of light, n is index of the medium between the two mirrors, L is the separation of the two mirror.

The spectral separation between the maxima, i.e., the free-Spectral-range (FSR) is given by

FSR=C/nL

For example, in a DWDM transmission with 50 GHz channel spacing, we can select a mirror gap L such that the period is 100 GHz, so that after the interleaver, the channel spacing becomes 100 GHz. For applications in DPSK and DQPSK demodulators, L should be tuned to match the one-bit delay requirement. For example, if the modulation frequency is 100 Gb/s, the one bit delay will be 10 ps. To match this delay the round trip light path difference should be around 3 mm in air.

The optical light path nd (index-path length product, nd, where n is the refractive index, d is the beam path between the two mirrors) determines the channel spacing of the interferometer. By thermally or mechanically changing n or d, the resonant frequency of the device can be made tunable.

### Second Embodiment

A second embodiment of the polarization based interferometer is shown in FIG. 3. Just like the embodiment shown in FIG. 2, it includes several beam shifters and wave plates. However, the phase shifter 3.5 here is a transmission type. Light path length of the phase shifter can be changed with thermo-optic or electro-optical effects, or mechanical movements.

In FIG. 3, unpolarized incident light is separated into two polarization components by YVO4 beam shifter 3.1 in z-direction. One of the two polarization components is rotated 90 degrees by half-wave plate 3.2. After half-wave plate 3.2 and quarter-wave plate 3.3, each of the two components is further divided into two arms in x-direction by beam shifter 3.4. Here 3.4 serves as a beam splitter. Phase shifter 3.5 in one of the two arms is used to change the light path difference between the two arms. Polarization beam splitter 3.6 is used as a beam combiner. Quarter-wave plate 3.7 and beam splitter 3.8 are employed to direct the light beams from the two arms into two output ports. Through wave plates 3.9 and 3.10, and beam shifter 3.11, the z-direction separated two components are recombined.

### Third Embodiment

Referring to FIG. 4, unpolarized incident light is separated into two polarization components by YVO4 beam shifter 4.2 in z-direction. Then one of the two polarization components is rotated 90 degrees by half-wave plate 4.3. After half-wave plate 4.3 and quarter-wave plate 4.4, each of the two components is further divided into two arms in x-direction by polarization beam splitter 4.5. In order to maintain the parallelism of the two beams after the polarization splitter, the polarization splitter 4.5's beam splitting interface 4.7 and reflection surface 4.6 are required to be parallel. Then quarter-wave plate 4.8 turns the light's polarization state by 90 degrees after a double pass. The light path difference between the two arms is dependent on the spacing among 4.5's beam splitting interface 4.7, reflector 4.6 and mirror 4.9, as well as the thickness of phase shifter 4.10. Light beams reflected from mirror 4.9 in the two arms are then combined by 4.5 and directed to beam shifter 4.13 after a quarter-wave plate 4.11. Through wave plates 4.14 and 4.15, and beam shifter 4.16, the z-direction separated two components are recombined. In order to couple the light into two balanced detectors or fibers 4.19, a prism 4.17 and a focusing lens 4.18 are employed.

### Forth Embodiment

Referring to FIG. 5, unpolarized incident light is separated into two polarization components by YVO4 beam shifter 5.1 in z-direction. One of the two polarization components is rotated 90 degrees by 5.2. Therefore after half-wave plates 5.2 and 5.3, both of the two components can be reflected by polarization beam splitters 5.4 and 5.6. Then quarter-wave plate 5.7 turns the light's polarization state from linear into circular. In order to maintain the parallelism of the two beams after the polarization splitter 5.8, the polarization splitter 5.8's beam splitting interface 5.9 and reflection surface 5.10 are required to be parallel. The light path difference between the two arms is dependent on the spacing among 5.8's beam splitting interface 5.9, reflector 5.10 and mirror 5.12, as well as the thickness of phase shifter 5.11. Light beams reflected from mirror 5.12 in the two arms are then combined by 5.8 and directed to polarization beam splitter 5.6 after passing quarter-wave plate 5.7. Polarization beam splitter 5.6 separates light into the two output ports depending on the phase shifts. Through beam shifters 5.14 and 5.17, the z-direction separated two components are recombined. In order to deflect the output beam from back into the input port, a circulator core 5.5 consisting of a Faraday rotator and a half-wave plate is used.

We claim that:

1. An optical interferometer composed of polarization optical components, including, but not limited to, beam shifters, waveplates, beam splitters and beam combiners.

2. The interferometer of claim 1 composing means for splitting an input light beam into two paths;
means for generating a controllable length difference between two paths;
means for recombining light from two paths;
means for directing recombined light into two output ports.

3. The first embodiment of the interferometer of claim 2 further includes two reflective surfaces. The light path difference between these two surfaces will determine the time delay and transmission frequency of the interferometer.

4. The second embodiment of the interferometer includes a beam splitting crystal.

5. The beam splitting crystal of claim 4 divides the incident light into two arms with a ratio controlled by a waveplate located in front.

6. The third embodiment of the interferometer of claim 2 includes a polarization beam splitter, a mirror, and a quarter wave plate located between the polarization beam splitter and the mirror. Also included is a waveplate located before the polarization beam splitter to control the beam splitting ratio.

7. The polarization beam splitter of claim 6 includes a reflection surface parallel to the beam splitting interface.

8. The reflection surface of claim 7 can be the interface between air and glass, or the interface between glass and reflective coatings.

9. The interferometer of claim 6 further includes a dual prism to direct the light into two output ports.

10. The forth embodiment of the interferometer of claim 2 includes a polarization beam splitter, a mirror, and a wave plate located in front the polarization beam splitter that controls the beam splitting ratio.

11. The interferometer of claim 10 further include a subassembly consisting of Faraday rotator and waveplate to direct light to output port.

12. The light path difference for the interferometers described in claim 3, claim 4, claim 6, and claim 10 can be changed by a phase shifter, using either thermal, piezoelectric, mechanical or electrical means.

13. Electrical means of claim 12 is an electro-optic phase modulator; the mechanical means is an acousto-optic phase modulator.

14. The optical interferometer of claim 1 and claim 2 used as DPSK or DQPSK demodulator by means of a controllable optical path length adjustment.

15. The means of optical path length adjustment for DPSK or DQPSK demodulator are those described in claim 12 and claim 13.
